(19) United States
(12) Patent Application Publication
(10) Pub. No.: US 2019/0033836 A1
(43) Pub. Date: Jan. 31, 2019

(54) SYSTEMS AND METHODS FOR VEHICLE MANUFACTURING

(71) Applicant: GM GLOBAL TECHNOLOGY OPERATIONS LLC, Detroit, MI (US)

(72) Inventors: Alexander Van Leuven, Gent (BE); Abel Banda, Round Rock, TX (US); Wade M. Leipold, Oxford, MI (US); Craig Turner, Cedar Park, TX (US); Jian L. Yang, Shanghai (CN)

(73) Assignee: GM GLOBAL TECHNOLOGY OPERATIONS LLC, Detroit, MI (US)

(21) Appl. No.: 15/662,009

(22) Filed: Jul. 27, 2017

(51) Int. Cl. G05B 19/418

(52) U.S. Cl. CPC G05B 19/41865; G05B 2219/32139

(57) ABSTRACT

Systems and methods of manufacturing a vehicle are provided. A part-vehicle includes a vehicle computing device. The vehicle computing device includes a memory, a communications device, and a processor, and the memory stores MES data for the vehicle. The vehicle computing device communicates MES data to manufacturing computing devices at different manufacturing workstations. The part-vehicle is manufacturing into the vehicle at the different manufacturing workstations according to the MES data.

### TECHNICAL FIELD

The present disclosure generally relates to vehicle manufacturing and more particularly relates to systems and methods for computerization of vehicle manufacturing processes.

### BACKGROUND

Vehicle manufacturing plants already make significant use of computerization including the use of robotics and other tools to assemble parts. Also, manufacturing execution systems, MES, are computerized systems used in manufacturing, to track and document the transformation of raw materials to finished goods. MES provides information that helps manufacturing decision makers understand how current conditions on the plant floor can be optimized to improve production output. MES works in real time to enable the control of multiple elements of the production process (e.g. inputs, personnel, machines and support services). Some MESs provide control systems for managing and monitoring work-in-process in a manufacturing facility. MESs may keep track of all manufacturing information in real time, receiving up-to-the-minute data from robots, machine monitors and employees.

It is desirable to provide systems and methods that allow further integration of manufacturing processes with MESs to increase the quality of information available, and allow greater manufacturing plant productivity and greater manufacturing flexibility. Furthermore, other desirable features and characteristics of the present invention will become apparent from the subsequent detailed description and the appended claims, taken in conjunction with the accompanying drawings and the foregoing technical field and background.

### SUMMARY

In one embodiment, there is provided a method of manufacturing a vehicle, comprising: providing a part-vehicle including a vehicle computing device, wherein the vehicle computing device includes a memory, a communications device, and a processor, and the memory stores manufacturing execution system, MES, data for the vehicle. The vehicle computing device communicates MES data to manufacturing computing devices at different manufacturing workstations. The method includes manufacturing the part-vehicle into the vehicle at the different manufacturing workstations according to the MES data.

In embodiments, the vehicle computing device communicates MES data including communicating manufacturing workstation specific manufacturing instructions.

In embodiments, the vehicle computing device geo positions the part-vehicle in a manufacturing plant to obtain geo-position data and communicates geo-position specific MES data based on the geo-position data.

In embodiments, the MES data includes order data for the vehicle.

In embodiments, the vehicle computing device receives and collects as-built data from manufacturing computing devices.

In embodiments, the method includes transmitting the as-built data to a server.

In embodiments, the vehicle computing device collects time and position data for the part-vehicle around a manufacturing plant. In embodiments, the method includes transmitting the time and position data to a server.

In embodiments, the method includes the vehicle computing device receiving an MES data update from a server.

In embodiments, manufacturing computing devices associated with respective workstations communicate as built MES data and the vehicle computing device stores the as built MES data

In another embodiment, a system for manufacturing a vehicle is provided. The system includes manufacturing workstations for performing manufacturing operations on a part-vehicle, the manufacturing workstations having respective manufacturing computing devices associated therewith. A vehicle computing device is associated with the part-vehicle as the part-vehicles moves through the manufacturing workstations and is manufactured into a vehicle, wherein the vehicle computing device includes a memory, a communications device, and a processor, and the memory stores manufacturing execution system, MES, data for the vehicle. The vehicle computing device is configured to communicate MES data to the manufacturing computing devices. The manufacturing computing devices are adapted to configure the manufacturing workstations based on the MES data.

In embodiments, the vehicle computing device is configured to communicate MES data including workstation specific manufacturing instructions. A manufacturing computing device is configured to receive the workstation specific manufacturing instructions and is adapted to configure its associated workstation to implement the workstation specific manufacturing instructions.

In embodiments, the vehicle computing device is configured to geo position the part-vehicle in a manufacturing plant to obtain geo-position data and to communicate geo-position specific MES data based on the geo-position data.

In embodiments, the vehicle computing device is configured to receive and store as-built data from the manufacturing computing devices.

In embodiments, the vehicle computing device is configured to collect time and position data for the part-vehicle around a manufacturing plant.

In embodiments, manufacturing computing devices associated with respective workstations are configured to communicate as built MES data and the vehicle computing device is configured to store the as built MES data.

In another embodiment, a vehicle is provided. The vehicle includes a vehicle computing device. The vehicle computing device includes a memory, a communications device, and a processor, and the memory stores manufacturing execution system, MES, data for the vehicle received from manufacturing computing devices during manufacturing at different workstations.

In embodiments, the MES data includes as built MES data.

In embodiments, the MES data includes manufacturing trace data, torque value data, defect data, defect repair data, defect containment data, work time spent.

In embodiments, the vehicle computing device includes a communications device configured to establish a communications channel with manufacturing computer devices, to transmit manufacturing instructions to the manufacturing computing devices, to receive as built data from the manufacturing computing devices and to store the as built data in the memory.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating a system for manufacturing a vehicle, in accordance with various embodiments;

FIG. 2 is a functional block diagram illustrating a vehicle computing device, in accordance with various embodiments;

FIG. 3 is a flowchart illustrating a method for manufacturing a vehicle, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

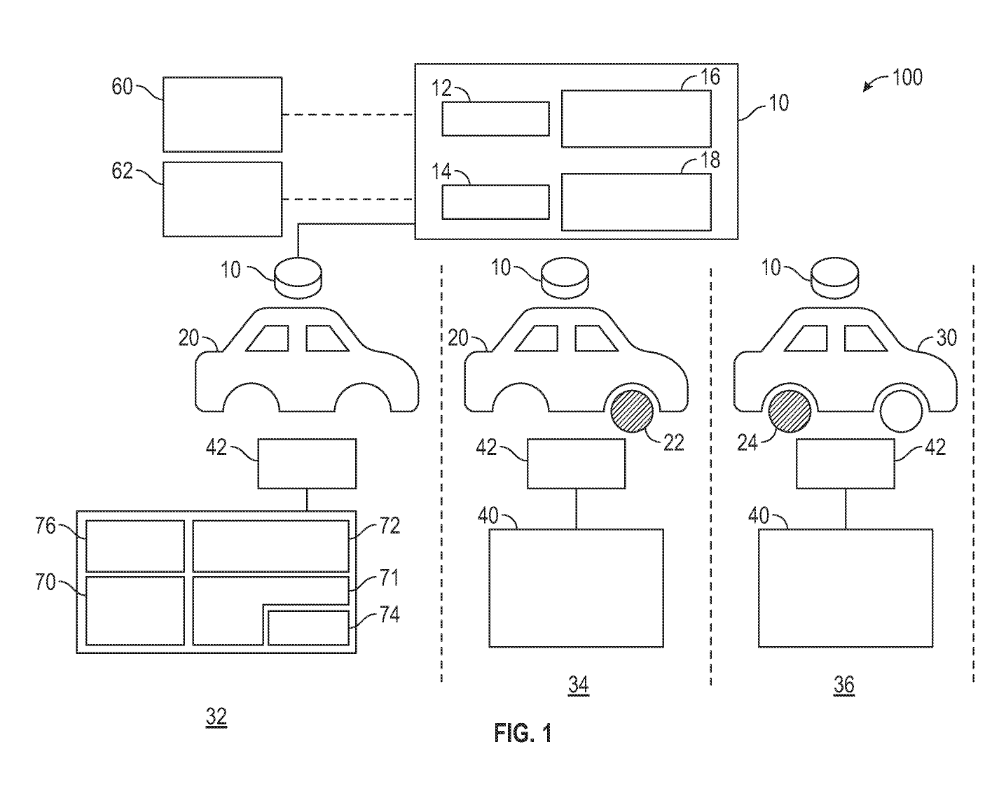

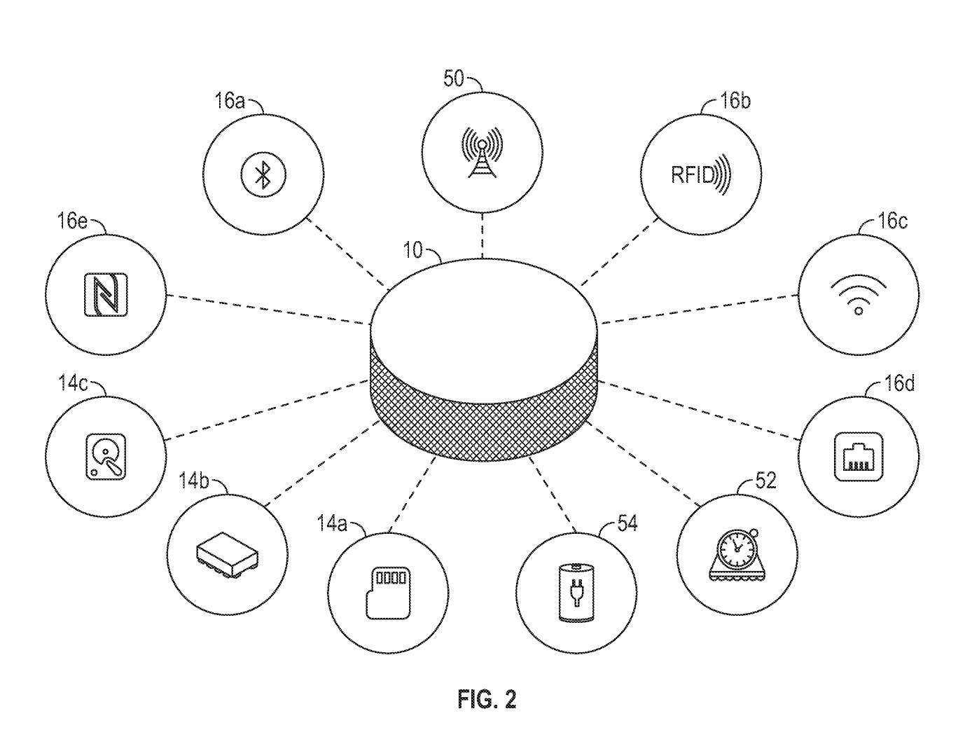

With reference to FIG. 1, a manufacturing system 100 is shown. The manufacturing system 100 schematically illustrates a part-vehicle 20 passing through manufacturing work stations 32, 34, 36 as the part-vehicle 20 is assembled into a market-ready vehicle 30. As used herein, a part-vehicle 20 is a not yet fully assembled vehicle passing through a manufacturing assembly as it undergoes further manufacturing processes at various workstations 32, 34, 36. The part-vehicle 20 is associated with a vehicle computing device 10, which includes at least a memory 14, a processor 12, a communications module/device 16 and other software and/or hardware components 18 as will be described further herein particularly with respect to FIG. 2. The memory 14 of the vehicle computing device 10 includes manufacturing execution system, MES, data. The vehicle computing device 10 is configured to communicate with manufacturing computing devices 40 at respective workstations 32, 34, 36 to relay the MES data stored in the memory 14 of the vehicle computing device 10. The manufacturing computing devices 40 are configured to receive the MES data, which includes, in some embodiments, manufacturing instructions for communicating to a human operator, for configuring tool(s) of the workstation 32 and/or for other purposes. The manufacturing computing devices 40 are configured to trace as-built MES data for the part-vehicle 20 and to communicate the as-built MES data to the vehicle computing device 10 for storage in the memory 14. The vehicle computing device 10 remains associated with the part-vehicle during manufacturing and optionally also with the market-ready vehicle 30 even after the vehicle 30 has gone to market and is in use.

In embodiments, the vehicle computing device 10 includes at least one processor 12 and a computer readable storage device/media or memory 14. The memory and the processor include a number of modules (as defined herein) for executing systems and methods as described herein, in accordance with various embodiments. The processor 12 can be any custom made or commercially available processor, a central processing unit (CPU), a graphics processing unit (GPU), an auxiliary processor among several processors associated with the vehicle computing device 10, a semiconductor based microprocessor (in the form of a microchip or chip set), a macroprocessor, any combination thereof, or generally any device for executing instructions. The computer readable storage device or memory 14 may include volatile and nonvolatile storage in read-only memory (ROM), random-access memory (RAM), and keep-alive memory (KAM), for example. The computer-readable storage device or memory 14 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the vehicle computing device 10 in controlling functions thereof.

The instructions may include one or more separate programs, each of which comprises an ordered listing of executable instructions for implementing logical functions. The instructions, when executed by the processor 12, control communications with the manufacturing computing devices 40, storage of as-built data and other MES functions as described herein. Although only one vehicle computing device 10 is shown in FIG. 1, embodiments of the vehicle computing device 10 can include any number of vehicle computing devices that communicate over any suitable communication medium or a combination of communication mediums and that cooperate to process the sensor signals, perform logic, calculations, methods, and/or algorithms, and generate control signals to automatically control MES features of the manufacturing system 100.

In accordance with various embodiments, the vehicle computing device 10 is a small-form-factor, SFF, computing device with smart phone capabilities. The vehicle computing device 10 is associated with, e.g. physically connected to, the part-vehicle 20 so that as the part-vehicle moves through workstations 32, 34, 36 of a manufacturing plant, the vehicle computing device 10 moves with the part-vehicle. In accordance with example embodiments, the vehicle computing device 10 is re-usable, which means that it would be removed from the market-ready vehicle 30 before dispatch to a customer or distribution network before being re-used in association with a new part-vehicle 20. In other envisaged uses, the vehicle computing device 10 is integrated with the vehicle 30 so that the vehicle computing device 10 leaves the manufacturing plant with the market-ready vehicle, 30 allowing authorized users down the supply line to access the MES data to, for example, ease product recalls.

The vehicle computing device 10 is loaded with MES data to be stored in the memory 14. In some embodiments, the vehicle computing device 10 is configured to communicate with a remote MES server 60 and/or a local MES server 62 (described further herein) to receive initial MES data and to transmit manufacturing MES data. The machine executable instructions described above are configured to manage such communications. In embodiments, the initial MES data is loaded into the memory 14 of the vehicle computing device 10 through wired or wireless communication. The initial MES data includes, in accordance with various embodiments, order details including selections for customizable options (i.e. option content) for the market-ready vehicle 30. A customer is able to make such selections prior to manufacturing the vehicle 30 and the selections are communicated to the vehicle computing device 10 from local and/or remote MES servers 60, 62. In embodiments, the MES data included in the memory 14 of the vehicle computing device 10 includes material data including bill of materials data, parts to be assembled data including customer selected parts and/or manufacturing processes data.

In embodiments, MES data stored in memory 14 of the vehicle computing device 10 additionally includes machine to machine and/or machine to human manufacturing instructions. Such manufacturing instructions include, in some embodiments, manufacturing details to be followed in order to assemble the part-vehicle 20 according to the order details included in the customer selections. In the case of machine to machine instructions, one or more manufacturing computing devices 40 at respective workstations 32, 34, 36 receive the instructions and automatically or semi-automatically configure the tools 42 to follow the instructions. In additional or alternative embodiments where the instructions include machine to human instructions, one or more of the manufacturing computing devices 40 are configured to communicate manufacturing instructions to an operator through an operator interface unit 70. The instructions are, in some embodiments, written instructions and, in other embodiments, the instructions are image and/or video files to be displayed to an operator or a combination thereof. The operator is then able to follow the instructions in order to manufacture the vehicle 30 as specified. In exemplary embodiments, the machine to machine and/or the machine to human manufacturing instructions include what to build (e.g. what part(s)), how to build (e.g. step-by-step instructions), what to check (e.g. what tests to perform), etc.

In embodiments, the vehicle computing device 10 includes geo-positioning capabilities. That is, the vehicle computing device 10 is configured to geo-position itself, and thus the part-vehicle 20, in a manufacturing plant to obtain geo-position data. One technique would be to geo-position the vehicle computing device 10 based on at least one reference source in the manufacturing facility. In one example, the reference source is a reference marker and the vehicle computing device 10 includes a scanner for reading the reference marker. In another example, the reference source is at least one transmission signal (e.g. wifi, radar, ultrasound, light) and the vehicle computing device 10 is configured to determine geo-position data based on a characteristic of the at least one transmission signal such as signal strength. In a further example, the reference source is at least one beacon device for use in geo-positioning. In various examples, a geo-position process uses triangulation and/or trilateration calculations to locate the vehicle computing device 10. In another example, the vehicle computing device 10 is configured to geo-position itself based on a received global positioning system, GPS, signal. For example, differential global position system, GPS, signal is used for enhanced accuracy. In another example, the vehicle computing device 10 is configured to capture at least one image and to geo-position itself based on image recognition techniques for the at least one image.

In embodiments, the vehicle computing device 10 is configured to communicate location specific MES data based on the current geo-position of the vehicle computing device 10. For example, different location specific MES data, optionally including different manufacturing instructions, is communicated at different workstations 32, 34, 36 as the vehicle computing device 10 will determine different geo-positions and adapt the MES data to communicate accordingly. The vehicle computing device 10 is, in some embodiments, configured to execute location specific communication protocols and/or to open location specific communication channels with the manufacturing computing device 40 based on the determined geo-position. In this way, the vehicle computing device 10 adapts communication set-up with the manufacturing computing devices 40 based on geo-position. The machine executable instructions described above include instructions for geo-positioning and adapting communications channels and the content of communications based on the geo-position. Since the MES data that is sent is location specific, and includes manufacturing instructions and/or order data in some examples, each workstation 32, 34, 36 is customizable based on customer order and is highly adaptive to real-time changes in manufacturing instruction as well as being adaptive to vehicle to vehicle differences in manufacturing processes.

In accordance with various embodiments, the vehicle computing device 10 is configured to capture as-built MES data. For example, the vehicle computing device 10 is configured to create an as-built record by capturing data resulting from processes and outcomes of the manufacturing process. In embodiments, the vehicle computing device 10 is configured to capture manufacturing events and actions. Merely by way of illustration, the as-built data includes torque data validation, defect collection, defect repair, defect containment, localization data, environmental data, and work time spent. In particular, the vehicle computing device 10 is configured to capture time spent at each location using the geo-position capabilities described above. In this way, production efficiency at different stages of a manufacturing plant is able to be determined. In various embodiments, the vehicle computing device 10 is configured to receive as-built data from the manufacturing computing devices 40 at each workstation 32, 34, 36 such as data on process(es) performed at the workstation 32, 34, 36, data captured from at least one sensor of the tool(s) 42 (e.g. torque data), data on part(s) installed, data on any defects or malfunctions, environmental data (e.g. temperature (which may alternatively be captured by a sensor of the vehicle computing device 10)), time data (which may alternatively be captured by a timer of the vehicle computing device 10)), etc. In embodiments, the machine executable instructions of the vehicle computing device 10 are configured to execute the MES type functions described herein including data capturing and optionally also data validation.

As shown in the exemplary embodiment of FIG. 1, the manufacturing system 100 includes remote and/or local MES servers 60, 62. The servers 60, 62 include suitable processing and memory capabilities to run an MES software system for generating and communicating an MES framework and data and for receiving as-built MES data for vehicle and production tracing functionalities. The remote servers 60, 62 are configured to transmit MES data to, and receive MES data from, the vehicle computing device 10 and similar/same vehicle computing devices 10 associated with other part-vehicle 20 and other market-ready vehicles 30. The remote MES server 60 is, in exemplary embodiments, a cloud based system. In other embodiments, a local MES 62 server is situated at the manufacturing plant.

In embodiments, the vehicle computing device 10 is configured to communicate with an MES system, particularly remote and/or local servers 60, 62 thereof. In such embodiments, the vehicle computing device 10 is configured to transmit data to the MES server 60, 62 either on request from the server 60, 62, at preset times (e.g at interval of every day, every hour, every minute, etc.), or at times decided upon by the vehicle computing device 10. For example, communication with the MES server 60, 62 is event initiated such as based on movement to a different workstation 32, 34, 36, completion of certain manufacturing process, etc. In embodiments, the communication between the vehicle computing device 10 and the MES server 60, 62 includes uploading or transmission of as-built data captured by the vehicle computing device 10. In embodiments, the communication between the vehicle computing device 10 and the MES server 60, 62 includes downloading or receipt of new MES data including new manufacturing processes, parts etc. In various embodiments, the vehicle computing device 10 is configured to interact continuously with an MES system to download new data or upload relavant as-built data and process data. In embodiments, the MES server 60, 62 is configured to establish a wireless network communication with authorized users, such as an end user, to allow the authorized user to enquire as to the location of a part-vehicle 20 or a market-ready vehicle 30 within a manufacturing facility using a vehicle identifier. The vehicle computing device 10 has geo-positioning capabilities as described herein, thereby allowing the MES server 60, 62 to return a result concerning location of the identified vehicle.

In accordance with various embodiments, the vehicle computing device 10 is configured to perform communications as described herein (e.g. communications with the MES server 60, 62, communications with the manufacturing computing devices 40 and communications with other computing devices such as roaming computing devices described later herein) through communications module 16. The communications module 16 includes communications hardware as well as software for performing the communications using the hardware such as implementing relevant communications protocols. With additional reference to FIG. 2, a range of possible communications modules are shown as examples. Additional and alternative communications schemes are possible. FIG. 2 illustrates communication modules 16a to 16e included in the vehicle computing device 10, which are provided in any combination or just one of them is provided. The communication modules 16a to 16e include a Bluetooth communication module 16a, an RFID communication module 16b, a WIFI communication module 16c, an ethernet communication module 16d, and a near field communication, NFC, module 16e. Additional or alternative communication modules could be provided.

Continuing to refer to FIG. 2, further hardware and/or software modules are illustrated as included in the vehicle computing device 10. In some embodiments, the vehicle computing device 10 includes an accelerometer 52, potentially providing useful MES data. In some embodiments, the vehicle computing device 10 includes an internal power source 54. The internal power source 54 is, in various alternatives, a solar power cell, a capacitor, a wireless power transfer device, a battery cell (e.g. a chemical battery cell), etc. The internal power source 54 provides power for the vehicle computing device 10 so that the vehicle computing device 10 is able to travel with the part-vehicle 20 without a wired power supply. In embodiments, the vehicle computing device 10 includes a GPS receiver 50 allowing the vehicle computing device 10 to geo-position itself as has been described heretofore. Further illustrated in FIG. 2 are memory devices as exemplary embodiments of the memory 14 including at least one of a local disk memory 14c, memory chip 14b and an external memory 14a, which is removable.

Referring back to FIG. 1, the workstations 32, 34, 36 each include tools 42 and a manufacturing computing device 40, in accordance with embodiments. The tools 42 are instruments used in assembling the part-vehicle 20 into the market-ready vehicle 30. Merely by way of example, first workstation 32 operates to install door handles (not shown), second work station 34 operates to assemble front wheels onto the part-vehicle 20, and third workstation 36 operates to assemble rear wheels on the part-vehicle 20. Tools 42 at the first workstation 32 include door handle fitting instruments. Tools 42 at second and third workstations include powered torque instruments. Tools 42 generally include powered instruments, torque applying instruments, lever instruments, impact instruments, layer applying instruments, boring instruments, etc. The tools 42 include hand-operated instruments and automated instruments (e.g. robot tools). For both hand-operated and automated tools 42, the tools are, in various embodiments, associated with a tool control module 72 of manufacturing computing devices for configuring settings of the tools 42 according to MES data, e.g. manufacturing instructions, received from the vehicle computing device 10.

The manufacturing computing devices 40 include at least a processor 76 and a memory 74 for controlling communications with vehicle computing devices 10 and for generating as-built MES data. In exemplary embodiments, the manufacturing computing devices 40 include an operator interface unit 70 such as a display device for communicating to a human operator MES data received from the vehicle computing devices 10 and for communicating other manufacturing relevant information. In embodiments, the manufacturing computing devices 40 include a tools control module 42 configured to control one or more functions of the tools 42 such as one or more settings (e.g. power settings) and controlling movement of the tools 42 and, in some embodiments, controlling automated operation of the tools 42. In embodiments, the manufacturing computing devices 40 include a communications module 78 configured for communicating with vehicle computing devices 10. The communications module 78 includes complementary communications hardware and/or software for establishing communication with communications module 16 of vehicle computing devices 10. Accordingly, Bluetooth, WIFI, RFID and/or NFC communications capabilities are included in communications module 78.

In embodiments, the manufacturing computing device 40 includes at least one processor 76 and a computer readable storage device/media or memory 74. The memory 74 and the processor 76 include a number of modules (as defined herein) for executing systems and methods as described herein, in accordance with various embodiments. The processor 76 can be any custom made or commercially available processor, a central processing unit (CPU), a graphics processing unit (GPU), an auxiliary processor among several processors associated with the manufacturing computing device 40, a semiconductor based microprocessor (in the form of a microchip or chip set), a macroprocessor, any combination thereof, or generally any device for executing instructions. The computer readable storage device or memory 74 may include volatile and nonvolatile storage in read-only memory (ROM), random-access memory (RAM), and keep-alive memory (KAM), for example. The computer-readable storage device or memory 74 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the manufacturing computing device 40 in controlling functions thereof.

The instructions may include one or more separate programs, each of which comprises an ordered listing of executable instructions for implementing logical functions. The instructions, when executed by the processor 76, control communications with the vehicle computing devices 10, generation of as-built data, operation of tools 42 and MES functions as described herein. Although only one manufacturing computing device 40 is shown in FIG. 1, embodiments of the vehicle 10 can include any number of manufacturing computing devices that communicate over any suitable communication medium or a combination of communication mediums and that cooperate to process the sensor signals, perform logic, calculations, methods, and/or algorithms, and generate control signals to automatically control MES features of the manufacturing system 100.

In embodiments, the manufacturing computing devices 40 are configured to receive MES data from the vehicle computing devices 10. The manufacturing computing devices 40 are configured to receive MES data, often location specific MES data as described above, and is responsive thereto to configure setting of the tools 42 through the tools control module 42 and/or to communicate relevant data to an operator through the operator interface unit 70. The MES data includes, in some embodiments, part(s) information identifying part(s) to be installed at the workstation 32 and/or manufacturing instructions and/or tools settings as has been described hereinbefore. The tools control module 72 is responsive to settings and/or manufacturing instructions, particularly machine to machine manufacturing instructions, to operate the tools 42. The operator interface unit 70 is adapted to display manufacturing instructions and/or part(s) information to allow an operator to follow the instructions and/or assemble part(s) identified in the part(s) information to the part-vehicle 20.

In an exemplary embodiment, the MES data at first workstation 32 identifies handle parts and manufacturing instructions for installing the handle parts. The handle parts are a customer selection in order data as described above, in some embodiments. The MES data is communicated from the vehicle computing device 10 to the manufacturing computing device 40. The processor 76 is configured to work with the operator interface unit 70 to display the handle parts identification information and the manufacturing instructions therefor. The operator assembles the handle parts according to the manufacturing instructions.

In an exemplary embodiment, the MES data at second workstation 34 identifies rear wheels to be assembled, tools to be used, torque to be applied and machine to machine manufacturing instructions. The rear wheels identified in the MES data are customer selectable components specified in the order data as described above, in some embodiments. Similar location specific MES data is communicated from the vehicle computing device 10 to the manufacturing computing device 40 at the third workstation 36. The tool control module 72 of the manufacturing computing device 40 at the second and third workstations 34, 36 is utilized to assemble the front and rear wheels identified in the MES data to the vehicle part 20 according to the machine to machine manufacturing instructions in a fully automated way. Optionally, some or all of the MES data is relayed to the operator interface unit 70 of the manufacturing computing devices 40 at respective workstations 34, 36 for operator inspection.

The manufacturing computing devices 40 are configured to communicate as-built data to the vehicle computing devices 10 identifying as-built data such as identification of parts installed, processes performed at each workstation, tooling used, recording of any defect events, and recording feedback of sensors (such as a torque sensor) of the tools 42. In addition to receiving feedback from the tools 42 and tool control module 72 to ascertain as-built data, the manufacturing computing device 40 is configured to establish as-built data based on operator entry through the operator interface unit 70. The vehicle computing devices 10 are configured to generate a record in the memory 14 of the as-built data.

In embodiments, the operator interface unit 70 includes a display device such as e-paper, wearable device, tablet, or any other device including a display screen. In various embodiments, the operator interface unit 70 includes display and operator interface capabilities. Operator input is provided in any of various ways such as mouse, touchpad, keyboard, touchscreen, voice recognition, and the like.

In various embodiments, roaming user devices (not shown) are able to communicate with vehicle computing device 10. In embodiments, the roaming user devices are located at the manufacturing facility, at a dispatch area, are devices located throughout the distribution network after manufacturing and/or are end-user devices. The roaming devices are configured to establish a communication channel once suitable handshaking and authorization protocols have been performed. Authorized roaming devices are configured to receive authorized MES data, including as-built data, from the vehicle computing device 10. In various embodiments, roaming devices include wearables, tablets, laptops, and other devices. In some embodiments, a customer device is configured to establish a communication channel with the vehicle computing device 10 to allow manufacturing progress of an order to be monitored. In some embodiments, roaming devices, particularly manufacturing plant roaming devices, associated (e.g. worn, carried or used) with plant operators are configured to communicate with the MES servers 60, 62. In some embodiments, the roaming devices have geo-positioning capabilities allowing them to be tracked within the manufacturing facility and such data is recorded at the MES servers 60, 62.

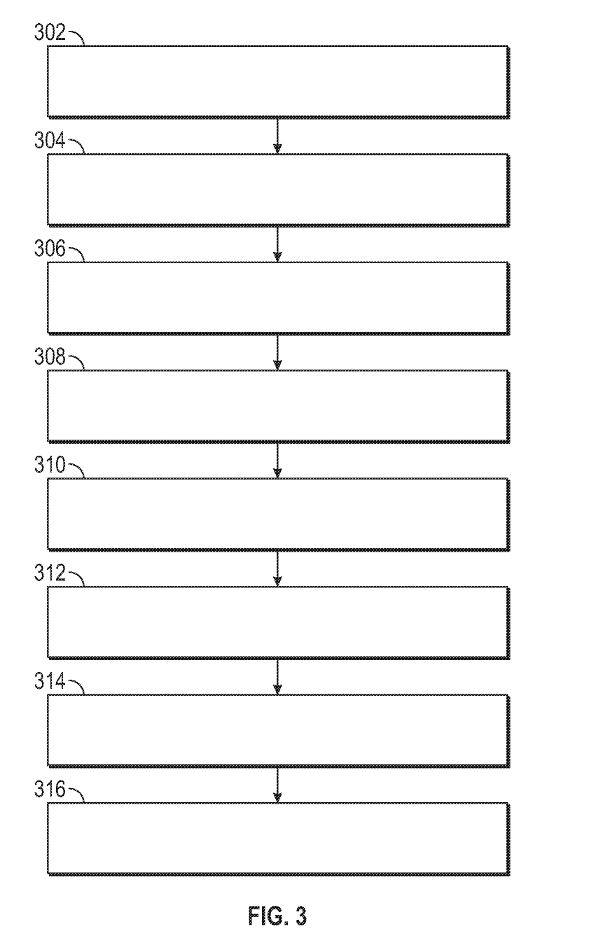

Referring now to FIG. 3, and with continued reference to FIGS. 1 and 2, a flowchart illustrates a method 300 that can be performed by the system 100 of FIGS. 1 and 2 in accordance with the present disclosure. As can be appreciated in light of the disclosure, the order of operation within the method 300 is not limited to the sequential execution as illustrated in FIG. 3, but may be performed in one or more varying orders as applicable and in accordance with the present disclosure. In various embodiments, the method 300 can be scheduled to run based on one or more predetermined events, and/or can run continuously during operation of the system 100.

In embodiments, the method 300 is a method of manufacturing a vehicle 30 by the part-vehicle 20 passing through various workstations 32, 34, 36 at which different manufacturing steps are performed. The method 300 includes step 302 of the part-vehicle 302 entering a workstation 32, 34, 36. The part-vehicle 302 includes the vehicle computing device 10 associated therewith, e.g. physically connected thereto. The vehicle computing device 10 is pre-loaded with order data for the vehicle 30 to be manufactured including customer selections as has been described previously.

In embodiments, the method 300 includes step 304 of the vehicle computing device 10 geo-positioning itself using any of a variety of techniques such as those described herein. In one example, the vehicle computing device uses GPS receiver 50 to determine its position within a manufacturing facility.

In embodiments, the method 300 includes step 306 of the vehicle computing device 10 communicating MES data to the manufacturing computing device 40 at the workstation 32, 34, 36. The MES data includes part identification, materials information, tools settings, tools identification and/or manufacturing instructions. The MES data is location specific in that a subset of MES data stored in the memory 14 of the vehicle computing device 10 is communicated to the manufacturing computing device based on the geo-position data determined in step 304.

In embodiments, the method 300 includes step 308 of the manufacturing computing device 40 adaptively operating based on the MES data communicated in step 306. Such adaptive operation includes displaying some or all of the MES data through operator interface unit such as written, image and/or video manufacturing instructions, in accordance with one example. Other examples include the tools control module 72 configuring settings such as power settings, movement of tools and/or full automation of the tools 42 based at least on manufacturing instructions included in the MES data.

In embodiments, the method 300 includes step 310 of performing manufacturing process(es) in the workstation 32, 34, 36. The manufacturing process is performed according to the settings of the tool control module 72 configured in step 308 and/or according to machine to machine manufacturing instructions received in step 306 and implemented in step 308 and/or according to manufacturing instructions communicated to an operator through operator interface unit 70. In embodiments, the method 300 includes many steps 302 to 310 as the part-vehicle 20 moves through many workstations at a manufacturing facility on its way to manufacture of a market-ready vehicle 30.

In embodiments, the method 300 includes step 312 of as built data being generated by the manufacturing computing device 40 at the workstation 32, 34, 36. The as built data includes at least one of as-built data based on feedback from one or more sensors associated with tool 42, as-built data received from vehicle computing device 10 such as acceleration data from accelerometer 52, geo-position data, time data, as-built data received from operator interface unit 70 such as data entered by operator, as-built data received from tools control module 72 including settings applied to tools 42, processes implemented, any events such as defect events, etc.

In embodiments, the method 300 includes step 314 of the as-built data generated in step 312 by the manufacturing computing device 40 being communicated to, and recorded in, the vehicle computing device 10. Such as-built data is stored in memory 14.

In embodiments, the method 300 includes step 316 of as-built data being communicated to, and recorded in, MES server 60, 62. The as-built data is communicated by the vehicle computing device 10 and/or the manufacturing computing device 40.

Other steps may be included in manufacturing method 300. For example, the MES server 60, 62 and/or the vehicle computing device 10 makes available the as-built data to authorized users such as end-customers and manufacturing plant personnel through a roaming computing device. In another example, work time spent is included in the as-built MES data included geo-position data within the manufacturing facility. In yet another example, the MES server 60, 62 and/or the vehicle computing device 10 makes available location data of the vehicle computing device, and thus the part vehicle 20 or market-ready vehicle, based on its geo-position.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of manufacturing a vehicle, comprising:
providing a part-vehicle including a vehicle computing device, wherein the vehicle computing device includes a memory, a communications device, and a processor, and the memory stores MES data for the vehicle;
communicating MES data, via the vehicle computing device, to manufacturing computing devices at different manufacturing workstations;
manufacturing the part-vehicle into the vehicle at the different manufacturing workstations according to the MES data.

2. The method of claim 1, wherein the step of communicating, via the vehicle computing device, MES data comprises communicating manufacturing workstation specific manufacturing instructions.

3. The method of claim 1, further comprising positioning, via the vehicle computing device geo, the part-vehicle in a manufacturing plant to obtain geo-position data and communicates geo-position specific MES data based on the geo-position data.

4. The method of claim 1, wherein the MES data includes order data for the vehicle.

5. The method of claim 1, further comprising: receiving and collecting, via the vehicle computing device, as-built data from manufacturing computing devices.

6. The method of claim 5, comprising transmitting the as-built data to a server.

7. The method of claim 1, further comprising collecting, via the vehicle computing device, time and position data for the part-vehicle around a manufacturing plant.

8. The method of claim 7, comprising transmitting the time and position data to an MES server.

9. The method of claim 1, comprising receiving an MES data update from an MES server.

10. The method of claim 1, comprising manufacturing computing devices associated with respective workstations communicating as built MES data and the vehicle computing device storing the as built MES data.

11. A system for manufacturing a vehicle, the system comprising:
one or more manufacturing workstations for performing manufacturing operations on a part-vehicle, the manufacturing workstations having respective manufacturing computing devices associated therewith; and
a vehicle computing device associated with the part-vehicle as the part-vehicles moves through the manufacturing workstations and is manufactured into a vehicle, wherein the vehicle computing device includes a memory, a communications device, and a processor, and the memory stores manufacturing execution system, MES, data for the vehicle;
the vehicle computing device configured to communicate MES data to the manufacturing computing devices; and
the manufacturing computing devices adapted to configure the manufacturing workstations based on the MES data.

12. The system of claim 11, wherein the vehicle computing device is configured to communicate MES data including workstation specific manufacturing instructions, wherein the manufacturing computing device receiving the workstation specific manufacturing instructions is adapted to configure its associated workstation to implement the workstation specific manufacturing instructions.

13. The system of claim 11, wherein the vehicle computing device is configured to geo position the part-vehicle in a manufacturing plant to obtain geo-position data and to communicate geo-position specific MES data based on the geo-position data.

14. The system of claim 11, wherein the vehicle computing device is configured to receive and store as-built data from the manufacturing computing devices.

15. The system of claim 11, wherein the vehicle computing device is configured to collect time and position data for the part-vehicle around a manufacturing plant.

16. The system of claim 11, wherein manufacturing computing devices associated with respective workstations are configured to communicate as built MES data and the vehicle computing device is configured to store the as built MES data.

17. A vehicle, comprising:
a vehicle computing device, wherein the vehicle computing device includes a memory, a communications device, and a processor, and the memory stores manufacturing execution system, MES, data for the vehicle received from manufacturing computing devices during manufacturing at different workstations.

18. The vehicle of claim 17, wherein the MES data includes as built MES data.

19. The vehicle of claim 17, wherein the MES data includes manufacturing trace data, torque value data, defect data, defect repair data, defect containment data, work time spent.

20. The vehicle of claim 17, wherein the vehicle computing device includes a communications device configured to establish a communications channel with manufacturing computer devices, to transmit manufacturing instructions to the manufacturing computing devices, to receive as built data from the manufacturing computing devices and to store the as built data in the memory.
